(19) United States
(12) Patent Application Publication
(10) Pub. No.: US 2009/0132100 A1
(43) Pub. Date: May 21, 2009

(54) Flight Control System

(76) Inventor: Hideki Shibata, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/909,076

(22) PCT Filed: Mar. 20, 2006
(86) PCT No.: PCT/JP2006/305513

§ 371 Date: Jun. 10, 2008

(30) Foreign Application Priority Data
Mar. 18, 2005 (JP) 2005-080773

(51) Int. Cl. G05D 1/00; G08B 23/00

(52) U.S. Cl. 701/2; 340/963

(57) ABSTRACT

An aircraft (1) and a terrestrial station (40) for communicating with each other are provided. An airframe and a payload device of an aircraft is controlled from the terrestrial station. The aircraft (1) transmits data concerning a situation of the airframe, a situation of a flight, and a situation of the payload device to the terrestrial station (40). The terrestrial station (40) includes one monitor screen (56) for simultaneously displaying all the data transmitted from the aircraft and an operation panel.

### CROSS-REFERENCE TO RELATED APPLICATIONS

This application is a U.S. National Phase of the International Application No. PCT/JP2006/305513 filed Mar. 20, 2006 designating the U.S. and published in Japanese on Sep. 21, 2006 as WO 2006/098469, which claims priority of Japanese Patent Application No. 2005-080773, filed Mar. 18, 2005.

### BACKGROUND OF THE INVENTION

1. Technical Field

The present invention relates to a flight control system of an aircraft and in particular relates to a flight control system of an aircraft for enabling communication between an unmanned helicopter and a terrestrial station for applying agrochemicals or the like or for mounting a camera device for recording a picture from the sky.

2. Description of the Related Art

Conventionally, a radio-controlled unmanned helicopter is used for applying agrochemicals from the sky or for recording aerial photographs or videos. As disclosed in Japanese Publication JP-A-2004-268737, for example, such a conventional unmanned helicopter includes an unmanned helicopter of a so-called autonomous control type, which can fly out of the operator's sight by using the GPS (Global Positioning System). An unmanned helicopter of an autonomous control type such as this is used in places such as a volcano and a disaster site, locations where it is difficult for a manned helicopter to reach.

Characteristically, an attitude of an unmanned helicopter is easily disturbed by wind. Further, structural features of such an unmanned helicopter result in extreme changes in attitude during a flight, for example, while a turn is made. An attitude of an unmanned helicopter is controlled mainly by servo motors of various types mounted on the airframe which change a tilt angle of the axis of the main rotor and a tilt angle of a blade of the main rotor and the tail rotor. If an unmanned helicopter of such a type is, for example, caught in a strong crosswind, the flight path may extremely diverge from an intended flight path. An autonomous control can also take a long time to correct a flight path.

An airframe or a flight status can be understood and appropriately controlled from the ground by providing a communication method of transmitting data between the airframe of a helicopter and a terrestrial station. The airframe operating condition described above includes an operation state of a servo motor for controlling an attitude of the airframe, an operation state of an engine, an operation state of various sensors detecting an attitude angle of the airframe and a rotational speed of the engine, the condition of a battery in use mounted on the airframe, and so forth. On the other hand, the flight status includes the current status in relation to the flight path such as a direction, an altitude, and a location of the unmanned helicopter flying, an operation state of a GPS device showing whether the GPS device is operating correctly, and so forth. Data on the operating condition of the airframe, the status of the flight, and so forth is transmitted from the airframe to the terrestrial station and displayed on a monitor screen of a personal computer provided in the terrestrial station.

When the unmanned helicopter is flying out of the operator's sight, the operator needs to always watch the data showing the operating condition of the airframe and the data showing the status of the flight in order to understand the operating state of the airframe and the status of the flight. Moreover, data communication is performed between a camera device and the terrestrial station, for example, in a case of an unmanned helicopter for recording pictures. In this case, the operator monitors a state of the camera device and, at the same time, makes an appropriate control as necessary by remote control.

An operation for changing the operating state of the airframe such as an attitude of the airframe and a speed of the airframe is performed by operating various servo motors on the airframe by remote control, using a joystick, a keyboard and a mouse of the personal computer, and so forth provided in the terrestrial station. On the other hand, an operation for changing the status of the flight such as a flight path and an altitude is performed by changing intended values, using the personal computer provided in the terrestrial station.

When a camera device is mounted on a conventional unmanned helicopter, a picture recorded by the camera device can be viewed by an operator at the terrestrial station. In such a case, the operator needs to know whether the camera device is working correctly. In other words, the operator needs to understand an operation state of the camera device.

While an unmanned helicopter is flying, the operator needs to keep paying attention to an instrument or the like displaying a large amount of data in order to control an attitude of the airframe, to monitor a flight path, to monitor components mounted on the airframe to know their normality or abnormality, and to control a payload device such as a camera and to monitor an operation thereof.

Consequently, such continuous monitoring can be taxing on the operator when the helicopter is operated for a long time. This is because it is extremely complex work to make an appropriate control by understanding the status of the airframe and flight and a state of the payload described above while watching a large amount of data.

In addition, it is difficult to make a quick decision without being skilled in such controlling and such monitoring described above. Some types of data may be displayed on a separate instrument or on a separate monitor screen. In a case like this, it is an extremely complex work to understand a situation by choosing necessary information.

### SUMMARY OF THE INVENTION

In view of the circumstances noted above, an aspect of the least one of the embodiments disclosed herein is to provide a flight control system in which it is easy to view data transmitted from the airframe and the payload device of the aircraft and an operation panel for making a control of the airframe and the payload device.

In accordance with one aspect of the invention, a flight control system is provided. The flight control system includes an aircraft and a terrestrial station for communicating with each other, the terrestrial station configured to control an airframe and a payload device of the aircraft, the aircraft configured to transmit data concerning an operating condition of the airframe, a status of a flight, and a status of the payload device to the terrestrial station, the terrestrial station comprising a monitor screen for simultaneously displaying all the data transmitted from the aircraft and an operation panel.

In accordance with another aspect of the invention, a method for controlling an aircraft during flight from a remote location is provided. The method comprises receiving data from the aircraft corresponding to at least one of an operating condition of the aircraft, a flight status and a status of a payload device of the aircraft. The method also comprises simultaneously displaying the received data on a monitor screen at the remote location, and transmitting at least one instruction to the aircraft to control the operation of the aircraft based at least in part on a review of said received data.

### BRIEF DESCRIPTION OF DRAW1NGS

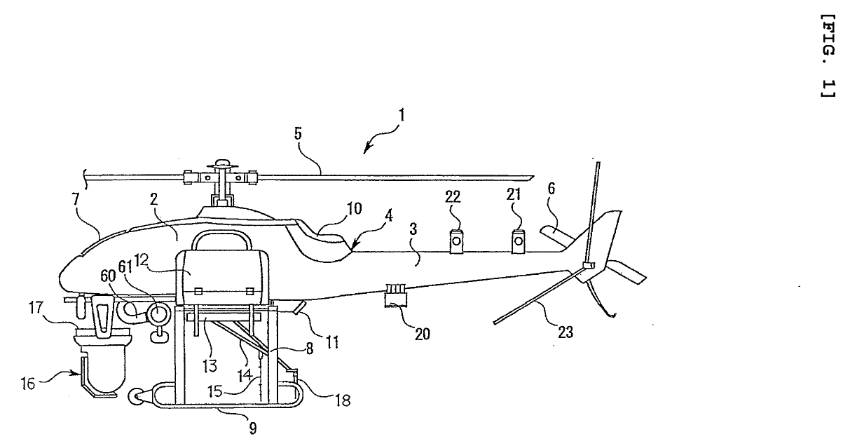

FIG. 1 shows a schematic side view of one embodiment of an unmanned helicopter.

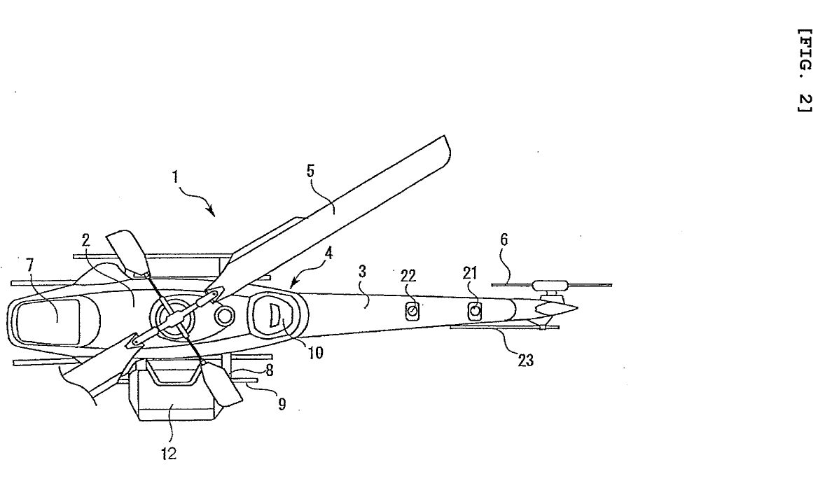

FIG. 2 shows a schematic top view of the helicopter in FIG. 1.

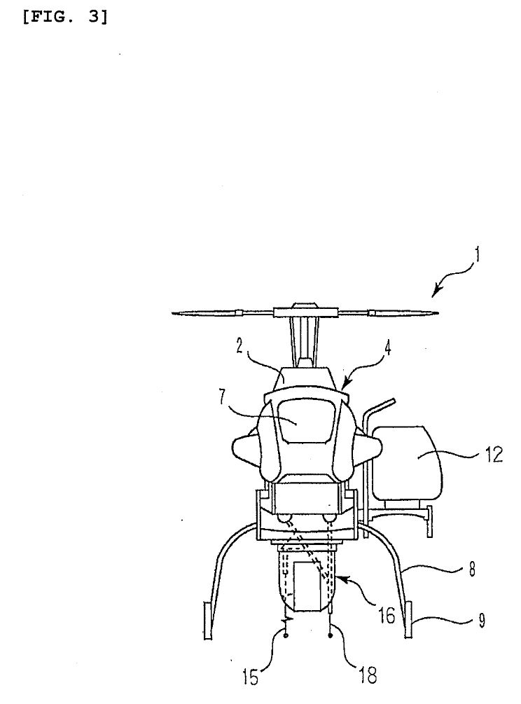

FIG. 3 shows a schematic front view of the helicopter in FIG. 1.

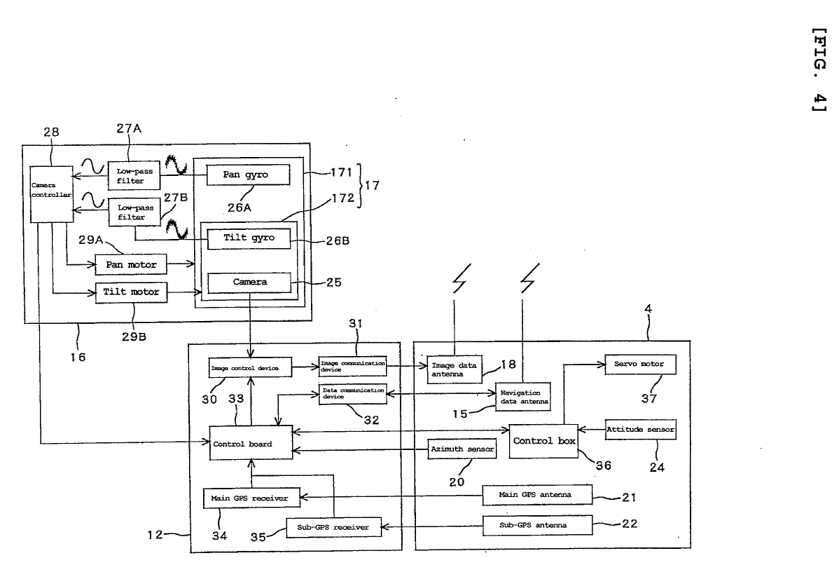

FIG. 4 shows a block diagram of an unmanned helicopter according to one embodiment.

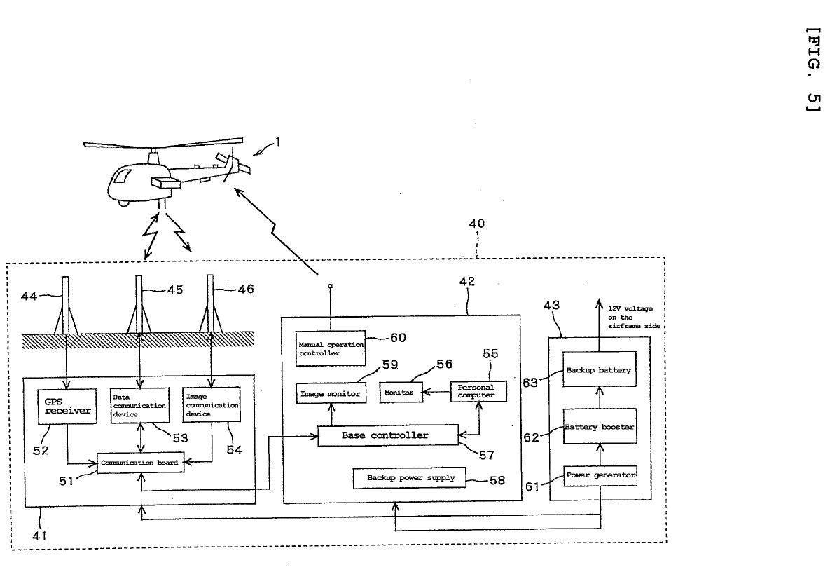

FIG. 5 shows a block diagram of a terrestrial station.

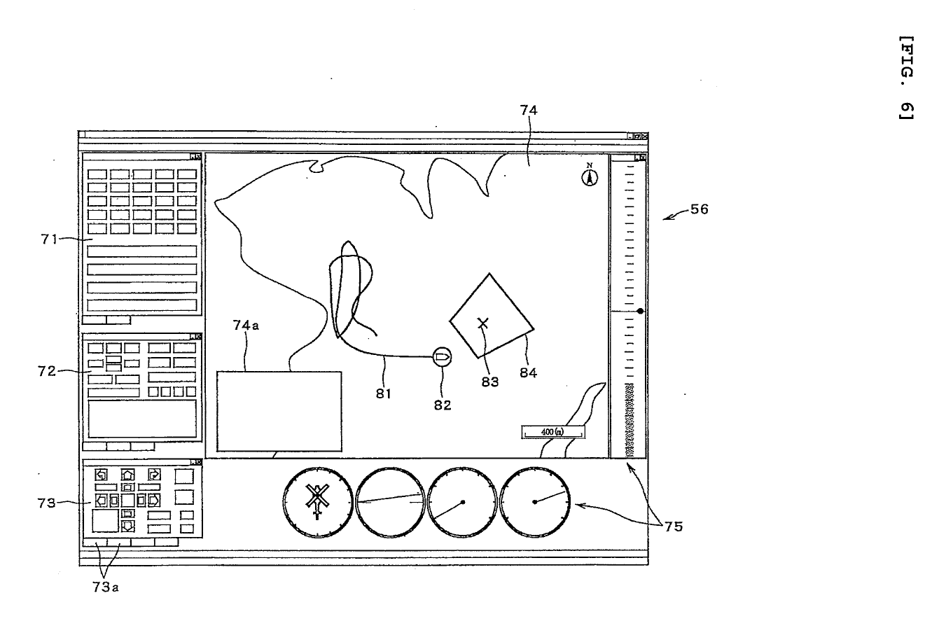

FIG. 6 shows a schematic front view illustrating an example of a display on a monitor at the terrestrial station.

### DETAILED DESCRIPTION OF THE PREFERRED EMBODIMENT

An embodiment of a flight control system will be described in detail hereinafter with reference to FIGS. 1 to 6. FIGS. 1 to 3 show a helicopter as an example of an aircraft according to the present invention, illustrating an unmanned helicopter provided with a camera device for recording an aerial photograph. FIG. 1 shows a side view, FIG. 2 shows a top view, and FIG. 3 shows a front view.

A helicopter 1 has an airframe 4 including a main body 2 and a tail body 3. A main rotor 5 is provided on the upper part of the main body 2, while a tail rotor 6 is provided on the rear part of the tail body 3. A radiator 7 is provided on the front part of the main body 2, behind which an engine, an intake system, a main rotor shaft, and a fuel tank are housed in this order in the main body 2. The fuel tank with a large capacity is housed in the vicinity of the center of the airframe in order to make an external sub-fuel tank unnecessary. A skid 9 is provided via a support leg 8 at the left and the right part under the main body 2 positioned generally in the center part of the airframe 4. An exhaust pipe 60 connected to the engine in the airframe (not shown in the drawing) and a muffler 61 connected to the exhaust pipe 60 are disposed above the front end of the skid 9 under the airframe.

A control panel 10 is provided on the upper side of the rear part of the main body 2, while an indicating lamp 11 is provided on the lower side thereof. The control panel 10 displays checkpoints, a result of a self diagnosis, and the like before a flight. Display on the control panel 10 is confirmed also at the terrestrial station. The indicating lamp 11 displays a state of a GPS control, an abnormality warning of the airframe, and so forth.

An autonomous control box 12 is mounted at the left side of the main body 2. In the autonomous control box 12, a GPS control device necessary for the autonomous control, a data communication device and an image communication device for performing communication with the terrestrial station, a control board containing a control program, and so forth are housed. During the autonomous control, an operation mode and the control program prescribed beforehand are selected automatically or according to an instruction from the terrestrial station depending on various data described below. Thus, a navigation control optimal for a situation of the airframe and a situation of a flight is performed. The various data described above includes airframe data such as an attitude, and a speed of the airframe, and a rotational speed and a throttle angle of the engine indicating a situation of the airframe and flight data such as a location and a direction of the airframe indicating a situation of the flight.

The helicopter 1 can fly by such autonomous control. In addition to the flight by the autonomous control described above, the helicopter 1 can fly by manual operation by the operator. Such a flight by manual operation is performed by the operator visually inspecting the attitude, the speed, the altitude, the direction, and so forth of the helicopter 1, while the operator operates a remote control device or a remote controller depending on the various data transmitted from the airframe.

A camera device 16 housing a camera such as an infrared camera is mounted under the front part of the main body 2 via a camera pan head 17. The camera device 16 rotates around a pan shaft (a vertical shaft) in relation to the camera pan head 17. In addition, an internal camera 25 (refer to FIG. 4) rotates around a tilt shaft (a horizontal shaft). As such a constitution is adopted, the camera device 16 can record pictures of all directions on the ground from the sky.

An antenna support frame 13 is attached to the bottom surface of the main body 2. An inclining stay 14 is attached to the antenna support frame 13. A data antenna 15 is mounted on the stay 14 for transmitting and receiving navigation data (digital data) such as the airframe data and the flight data necessary for the autonomous control described above to and from the terrestrial station. Further, an image data antenna 18 for transmitting image data recorded by the camera device 16 to the terrestrial station by image communication of an analog type is attached to the stay 14. Besides the analog type, a digital type can be adopted for the image communication.

An azimuth sensor 20 based on terrestrial magnetism is provided on the bottom side of the tail body 3. A direction in which the airframe points, such as east, west, south and north is detected by the azimuth sensor 20. In addition, an attitude sensor 24 constituted by a gyro device (refer to FIG. 4) is provided inside the main body 2.

A main GPS antenna 21 and a sub-GPS antenna 22 are provided on the upper surface of the tail body 3. A remote control receiving antenna 23 for receiving an instruction signal from the remote controller is provided at the rear end of the tail body 3.

FIG. 4 shows a block diagram of the unmanned helicopter according to one embodiment.

The camera pan head 17 includes a turntable 171 rotatable around the pan shaft and a support frame 172 rotatable around the tilt shaft, both of which have a pan gyro 26A and a tilt gyro 26B for detecting a tilt thereof. Further, the camera device 16 has a camera controller 28 for receiving a low frequency component of the data from the pan gyro 26A and the tilt gyro 26B from which a high frequency component has been removed via low-pass filters 27A and 27B. The camera device 16 is provided with a pan motor 29A and a tilt motor 29B for operating the turntable 171 and the support frame 172 based on a signal of the camera controller 28.

An attitude correction section of the camera 25 includes the camera controller 28, the pan gyro 26A, the tilt gyro 26B, the pan motor 29A, and the tilt motor 29B. In the camera device 16, when a low frequency component caused by the tilt around the pan shaft or the tilt shaft of the unmanned helicopter 1 is detected, a motor is actuated in the direction opposite to the direction of the tilt. Consequently, a movement in low frequency is canceled, and an image is stabilized.

The autonomous control box 12 houses an image control device 30 for overlaying a character after receiving image data from the camera 25 from which a high frequency component and a low frequency component have been removed by the attitude correction section and also for switching an image in a case in which a plurality of cameras is mounted, an image communication device 31 for transmitting image data to the terrestrial station, a data communication device 32 for transmitting and receiving data necessary for the autonomous control to and from the terrestrial station, a control board 33 including a microcomputer storing an autonomous control program and so forth, a main GPS receiver 34 connected to the main GPS antenna 21, and a sub-GPS receiver 35 connected to the sub-GPS antenna 22.

The airframe 4 has the image data antenna 18 for transmitting analog image data from the image communication device 31 in the autonomous control box 12 to the terrestrial station. The airframe 4 has the data antenna 15 for transmitting and receiving digital data between the data communication device 32 and the terrestrial station. The azimuth sensor 20 is connected to the control board 33 in the autonomous control box 12. The attitude sensor 24 including a gyro device and so forth is provided inside the airframe 4. The attitude sensor 24 is connected to a control box 36. The control box 36 performs data communication with the control board 33 in the autonomous control box 12 and actuates a servo motor 37. The servo motor 37 controls the main rotor 5 and the engine in order to control a movement of the airframe 4 in the longitudinal direction, in the width direction, and in the vertical direction and also controls the tail rotor 6 in order to control the rotation of the airframe 4.

FIG. 5 shows a block diagram of the terrestrial station.

A terrestrial station 40 for communicating with the helicopter 1 is provided with a GPS antenna 44 for receiving a signal from a GPS satellite, a communications antenna 45 for performing data communication to and from the helicopter 1, and an image receiving antenna 46 for receiving image data from the helicopter 1. The antennas 44 to 46 are provided on the ground.

The terrestrial station 40 includes a data processing section 41, a monitoring operation section 42, and a power supply section 43.

The data processing section 41 includes a GPS receiver 52, a data communication device 53, an image communication device 54, and a communication board 51 connected to these components for performing communication.

The monitoring operation section 42 includes a manual operation controller 60 operated by the remote controller, a base controller 57 for operating the camera device, adjusting flight data of the airframe 4, and so forth, a backup power supply 58, a personal computer 55 connected to the base controller 57, a monitor screen 56 for the personal computer 55, and an image monitor 59 connected to the base controller 57 for displaying image data.

The power supply section 43 includes a power generator 61 and a backup battery 63 connected to the power generator 61 via a battery booster 62. The backup battery 63 is connected to the side of the airframe 4 in order to supply electric power of 12V when the power generator 61 is not operated, for example, while a check is made before a flight. Further, the power supply section 43 supplies electric power of 100V from the power generator 61 to the data processing section 41 and the monitoring operation section 42 while the helicopter 1 is flying.

In the constitution described above, an instruction concerning a flight of the helicopter 1 is programmed by the personal computer 55 at the terrestrial station 40 and transmitted from the terrestrial station 40 to the helicopter 1 via the data processing section 41. When the data antenna 15 of the helicopter 1 receives the instruction, the attitude and the location of the airframe 4 are controlled by the control board 33 (refer to FIG. 4). Thus, the autonomous control of the helicopter 1 is performed.

Data on the airframe operating condition, the flight status and the like is transmitted from each sensor provided on the airframe 4 of the helicopter 1 to the terrestrial station 40, at which the data is displayed on the monitor screen 56 of the personal computer 55 in real time. The operator monitors the helicopter 1 by viewing the display. The flight condition or the like of the flying helicopter 1 can be corrected by remote control with the personal computer 55 or the manual operation controller 60.

FIG. 6 illustrates an example of a display on the monitor screen 56 of the personal computer 55 provided in the terrestrial station 40.

An airframe information display section 71, a payload device information display section 72, and a navigation panel display section 73 for the airframe 4 are displayed in this order from the top to the bottom at the left side on the monitor screen 56.

Data showing the operating condition of the airframe and the flight status of the helicopter 1 and operation states of components such as the servo motor 37, various sensors, and so forth are displayed on the airframe information display section 71 by lamp, by value, or by character described below.

Items displayed by lamp include a voltage of a battery (not shown in the drawing) mounted on the airframe 4, an amount of used fuel, output states of various sensors, and operation states of the GPS receivers 34 and 35 and other various control devices. The items displayed by lamp are displayed by using different colors, for example, green or a similar color for a completely normal case, yellow or a similar color for a case in which operation is normal but a part of information is lacked, and red or a similar color for a case in which a problem or an error has occurred.

Moreover, when the color of a lamp is changed to red, a warning sound is generated from a speaker or the like (not shown in the drawing) provided on the monitoring operation section 42.

A means for visually showing abnormal operation of a component of the aircraft is achieved by the constitution for performing display in red or in a similar color as described above. On the other hand, a means for auditorily indicating abnormal operation is achieved by the constitution for sounding a warning in a case of abnormality.

Items displayed by value described above include detailed information on the GPS (latitude, longitude, altitude, and so forth), temperature of cooling water of the engine, a battery voltage, and so forth. In this case, as well as the case of displaying by lamp, a figure or a background thereof is colored on the display according to classification of a state. When a value is out of a prescribed range, a warning is sounded, too. Items displayed by character include a situation of communication from the airframe 4 of the helicopter 1, a flight time, a state of the navigation by the GPS, whether a control is allowed or not, size of a control level, and so forth.

When all the display is in green, indicating normality, the operator does not need to particularly watch the airframe information display section 71. On the other hand, when the display is changed into a color other than green or when a warning is sounded, the operator understands a situation of the airframe based on the state of the display and takes a necessary action.

When, for example, a camera device having a pan function and a tilt function is mounted on the helicopter 1 for recording a picture, an operation panel for controlling the camera, for operating a pan angle and a tilt angle of the camera pan head, and the like is displayed on the payload device information display section 72. In such a case, information for confirming an operation mode relevant to this example is displayed as well as the display described above. When a payload is, for example, an applying device for applying agrochemicals from the sky other than the device described above, an operation panel and so forth for controlling the applying device is displayed.

A navigation dialog box for inputting a target speed of the airframe, a relative movement dialog box for inputting a moving distance and an angle of the airframe, a parameter dialog box for changing a control parameter for the airframe, a program flight dialog box for transmitting and controlling a flight program, and so forth are displayed on the navigation panel display section 73. These dialog boxes are switched, for example, by a task button 73a and a necessary dialog box is displayed on the monitor screen 56 for operation. A page is switched by each task button corresponding to each content of information on the airframe information display section 71 and the payload device information display section 72. Thus, information necessary for each occasion is displayed.

An instrument display section 75 including a plurality of instruments from which the current operating condition of the airframe or the current flight status of the airframe 4 are known is displayed at the right side in the lower section of the monitor screen 56. The instrument display section 75 displays a rotational speed of the engine controlled by the control box 36, a horizontal speed and a vertical speed recognized by the GPS, a heading and altitude recognized from the azimuth sensor and the attitude sensor, and a horizon indicator showing an attitude angle of the airframe, and so forth. The items above are visually displayed by using a graphical figure and the like. In particular, an area requiring special caution is displayed in red or in a color similar to red. In addition, if special caution is required, a warning sound may be generated from the speaker provided in the monitoring operation section 42.

A map 74 of a region over which the helicopter 1 is flying is displayed in the middle section on the monitor screen 56. The map 74 displays a topographical map of the region of the flight, a direction, and a scale. A trajectory of the flight path of the helicopter 1 is indicated by a line 81 on the topographical map. An airframe mark 82 indicating the current position and the heading direction of the airframe is shown at an end of the line 81. An image display section 74a for displaying an image recorded by the camera 25 may be provided on a part of the map screen. A still picture or a motion picture is displayed as an image in the image display section 74a.

A view point 83 of the camera is indicated, for example, by an “x” mark on the map 74. The view point 83 is calculated from the altitude and the direction of the airframe transmitted from the airframe of the helicopter 1 to the terrestrial station and the pan angle and the tilt angle transmitted from the camera device 16. Moreover, an area recorded by the camera 25 is displayed on the map as a field of view 84 depending on a viewing angle of the camera. An area nearer to the camera is narrower in the field of view 84, while an area farther from the camera is wider in the field of view 84. Accordingly, the field of view 84 is in the shape of a trapezoid on the map.

Each display section described above is displayed on the monitor screen 56 of the personal computer 55 by multitasking, and size and a position of an area of each display section can be arbitrarily changed by operation of the mouse connected to the personal computer 55. Further, each display section is switched to be displayed or not to be displayed. Accordingly, it is possible to temporarily hide information not necessary for each occasion. Therefore, an arrangement of each display section is not limited to an example in FIG. 6. Consequently, the operator can display each display section in a size and an arrangement with which it is easy for the operator to view each display section. Necessary information can be displayed according to the operating condition of the airframe and the flight status. Such a display setting is memorized even after the program has been ended on the personal computer 55. In addition, it is possible to reset the display by setting to an initial setting by a simple operation.

According to the flight control system of an embodiment of the present invention, it is possible to confirm all information concerning the operating condition of the airframe, the flight status, and the operation of the payload device of the helicopter 1 on one monitor screen 56. Consequently, according to the flight control system, the operator can confirm all information concerning the helicopter 1 only by monitoring the contents on the monitor screen 56 without watching a plurality of instruments. As a result, the movement of an operator's line of sight can be reduced during a flight, thereby relieving the operator from tiredness.

According to the flight control system of the embodiment of the present invention, displayed contents on the monitor screen 56 are changed corresponding to the operating condition of the airframe, flight status, and the operation of the payload device, and it is possible to hide an item not necessary for confirmation or for operation for each occasion. By hiding such items, it is possible to prevent the operator from uselessly viewing unnecessary information. According to the flight control system, since only necessary information and the operation panel (each type of the dialog boxes described above) are displayed, the operator can concentrate on monitoring and operating such necessary information and the operation panel. Further, as unnecessary information is not displayed, it is possible to display only necessary information in an easily viewable size in a space on the monitor screen 56 having a limited space.

According to the flight control system of the embodiment of the present invention, it is possible to color a display in red or in yellow or to generate a warning sound corresponding to a level of abnormality when abnormality occurs. Consequently, the operator does not need to pay attention closely to all information all the time, but the operator only has to inspect whether or not any abnormality has occurred. Therefore, the operator becomes less tired, while he or she does not overlook abnormality even during a long flight.

The present invention can be applied to an aircraft such as an unmanned helicopter, a manned helicopter, another airplane, and the like regardless of presence of a payload device such as a camera device.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

1-3. (canceled)

4. A flight control system, comprising:
an aircraft and a terrestrial station for communicating with each other the terrestrial station configured to control an airframe and a payload device of the aircraft,
the aircraft configured to transmit data concerning an operating condition of the airframe, a status of a flight, and a status of the payload device to the terrestrial station,
the terrestrial station comprising a monitor screen for simultaneously displaying all the data transmitted from the aircraft and an operation panel.

5. The flight control system of claim 4, wherein a desired item is selected from all the data transmitted from the aircraft and the operation panel and displayed on the monitor screen in an arbitrary arrangement and size.

6. The flight control system of claim 4, further comprising means for indicating an abnormal operation of a component of the aircraft in at least one of a visual and an auditory manner when the data transmitted from the aircraft is outside a normal operating range.

7. A method for controlling an aircraft during flight from a remote location, comprising:
receiving data from the aircraft corresponding to at least one of an operating condition of the aircraft, a flight status and a status of payload device on the aircraft;
simultaneously displaying the received data on a screen at the remote location; and
transmitting at least one instruction to the aircraft to control the generation of the aircraft based at least in part on a review of said received data.

8. The method of claim 7, further comprising selecting a desired data item from the received data and displaying said desired date item on the monitor screen.

9. The method of claim 7, further comprising determining whether any of the received data is outside a normal operating range.

10. The method of claim 9, wherein displaying comprises indicating an abnormal operation of a component of the aircraft at least one of visually and auditorily when any of the received data is outside the normal operating range.

11. The method of claim 7, wherein displaying includes displaying the received data in an arbitrary arrangement and size.
